(19) United States
(12) Patent Application Publication
(10) Pub. No.: US 2022/0416620 A1
(43) Pub. Date: Dec. 29, 2022

(54) ELECTRIC GENERATOR WITH ISOLATED ROTOR MAGNETS

(71) Applicant: Rolls-Royce Corporation, Indianapolis, IN (US)

(72) Inventor: Tina S. Pryde, Ranheim (NO)

(21) Appl. No.: 17/361,945

(22) Filed: Jun. 29, 2021

(51) Int. Cl. H02K 7/18; H02K 1/02; H02K 1/28; H01F 1/055; F02C 6/00

(52) U.S. Cl. CPC H02K 7/1823; H02K 1/02; H02K 1/28; H01F 1/055; F02C 6/00; F05D 2220/76; F05D 2240/24

(57) ABSTRACT

A gas turbine engine includes a fan and a rotor assembly. The rotor assembly includes a rotor, a plurality of magnets, and an annular retaining sleeve. The rotor includes a radially outer wall spaced apart from a central axis of the engine by an axially forward and an axially aft annular end wall. The magnets are located radially outward of the rotor and arranged on the outer wall in axial alignment with each other, the magnets being configured to move radially relative to each other and remain in contact with the outer wall in response to elastic deformation of the outer wall. The sleeve radially surrounds the magnets so as to structurally support and secure the magnets to the rotor, the sleeve being elastically deformable in the radial direction and configured to elastically deform based on the radial movement of the magnets.

### FIELD OF THE DISCLOSURE

The present disclosure relates generally to gas turbine engines, and more specifically to auxiliary electric power devices of gas turbine engines.

### BACKGROUND

Gas turbine engines are used to power aircraft, watercraft, electrical generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Exhaust products of the combustion reaction in the combustor are directed into the turbine where work is extracted to drive the compressor and, sometimes, an output shaft, fan, or propeller. Portions of the work extracted from the turbine can be used with various subsystems such as motor-generators.

### SUMMARY

The present disclosure may comprise one or more of the following features and combinations thereof.

A gas turbine engine according to the present disclosure includes a fan arranged around an axis and configured to generate thrust, a turbine configured to generate rotational energy, and a drive shaft that extends along the axis and transfers the rotational energy from the turbine to the fan and a rotor assembly for a motor-generator. The rotor assembly includes a rotor, a plurality of magnets, and an annular retaining sleeve.

In at least some embodiments, the rotor is arranged to circumferentially surround the axis and rotationally coupled to the drive shaft, the rotor including a radially outer wall that is elastically deformable in a radial direction and having an axially forward end and an axially aft end, an axially forward annular end wall arranged on the axially forward end of the radially outer wall, and an axially aft annular end wall arranged on the axially aft end of the radially outer wall, the radially outer wall being spaced apart from the axis by the axially forward and the axially aft annular end walls.

In at least some embodiments, the plurality of magnets are located radially outward of the rotor and arranged on the radially outer wall in axial alignment with each other so as to form an axial row of magnets, the plurality of magnets being configured to move radially relative to each other and remain in contact with the radially outer wall in response to elastic deformation in the radial direction of the radially outer wall. The annular retaining sleeve radially surrounds the plurality of magnets so as to structurally support and secure the plurality of magnets to the rotor, the annular retaining sleeve being elastically deformable in the radial direction and configured to elastically deform in the radial direction based on the radial movement of the plurality of magnets.

In at least some embodiments, the radially outer wall includes a radially outer surface, wherein each magnet of the plurality of magnets includes an axially facing surface facing an adjacent magnet and a radially inward facing surface facing the radially outer wall, and wherein a bonding material is disposed between the radially inward facing surface of each magnet of the plurality of magnets and the radially outer surface of the radially outer wall for securing the magnet to the radially outer wall.

In at least some embodiments, the axially facing surface of each magnet of the plurality of magnets is material-free so as to allow for the radial movement of the plurality of magnets relative to each other.

In at least some embodiments, each magnet of the plurality of magnets includes a radially outer surface, and wherein the annular retaining sleeve contacts at least a portion of the radially outer surface of each magnet of the plurality of magnets in response to the radial movement of the plurality of magnets relative to each other.

In at least some embodiments, each magnet of the plurality of magnets is in contact with each other on the axially facing surface of each magnet.

In at least some embodiments, the annular retaining sleeve has an axially forward end and an axially aft end, wherein the annular retaining sleeve includes a forward radially extending end wall extending away from the axially forward end of the annular retaining sleeve and an aft radially extending end wall extending away from the axially aft end of the annular retaining sleeve, and wherein the forward radially extending end wall and the aft radially extending end wall enclose at least a portion of an axially forwardmost magnet of the plurality of magnets and at least a portion of an axially aftmost magnet of the plurality of magnets so as to retain the plurality of magnets in an axial direction.

In at least some embodiments, the radially outer wall defines a rotor wall radial thickness, the annular retaining sleeve defines a sleeve radial thickness, and a ratio of the rotor wall radial thickness to the sleeve radial thickness is 6 to 5.

In at least some embodiments, the radially outer wall defines a rotor wall radial thickness, each magnet of the plurality of magnets defines a magnet radial thickness, and a ratio of the magnet radial thickness to the rotor wall radial thickness is 8 to 3.

In at least some embodiments, the radially outer wall defines a rotor wall radial thickness of 3 mm, each magnet of the plurality of magnets defines a magnet radial thickness of 8 mm, and the annular retaining sleeve defines a sleeve radial thickness of 2.5 mm.

In at least some embodiments, the Young's modulus of the radially outer wall is in a range of 160 GPa to 210 GPa, and the Young's modulus of the annular retaining sleeve is in a range of 180 GPa to 210 GPa.

In at least some embodiments, the plurality of magnets are made of samarium cobalt.

In at least some embodiments, the rotor assembly includes a plurality of axial rows of magnets arranged circumferentially around the radially outer wall of the rotor.

In at least some embodiments, the annular retaining sleeve includes a plurality of annular ring segments arranged axially adjacent to each other so as to form the annular retaining sleeve.

According to another aspect of the present disclosure, a rotor assembly of an electrical device for use in a gas turbine engine includes a hollow rotor, a plurality of magnets, and an annular retaining sleeve. The hollow rotor is configured to rotate about an axis and deform elastically radially in response to rotation about the axis. The plurality of magnets is arranged radially outward of the hollow rotor so as to form an axial row whereby the plurality of magnets are aligned circumferentially.

In at least some embodiments, the annular retaining sleeve radially surrounding the plurality of magnets so as to structurally support and secure the plurality of magnets with the hollow rotor, the annular retaining sleeve being elastically deformable. The plurality of magnets are not coupled with one another to allow the plurality of magnets to move relative to each other in response to elastic deformation of the hollow rotor, and the annular retaining sleeve is configured to elastically deform with the radial movement of the plurality of magnets while retaining the plurality of magnets in contact with the hollow rotor.

In at least some embodiments, each magnet of the plurality of magnets includes an axially facing surface that faces an adjacent magnet of the plurality of magnets and a radially inward facing surface that faces the hollow rotor, wherein a bonding material is disposed between the radially inward facing surface of each magnet of the plurality of magnets and the hollow rotor to couple the plurality of magnets with the hollow rotor.

In at least some embodiments, the axially facing surface of each magnet of the plurality of magnets and any axial space between adjacent magnets is free of material so as to allow for the radial movement of the plurality of magnets relative to each other.

In at least some embodiments, each magnet of the plurality of magnets includes a radially outer surface, and wherein the annular retaining sleeve contacts at least a portion of the radially outer surface of each magnet of the plurality of magnets in response to the movement of the plurality of magnets relative to each other.

In at least some embodiments, each magnet of the plurality of magnets is in contact with each other on the axially facing surface of each magnet.

According to another aspect of the present disclosure, a method of assembling a rotor assembly of an electrical device for use in a gas turbine engine includes providing a hollow rotor arranged to circumferentially surround a central axis of the engine, the hollow rotor having a radially outer wall that is elastically deformable in a radial direction. The method further includes applying a bonding material to at least one of a radially inward facing surface of each magnet of a plurality of magnets and an outer surface of the radially outer wall without applying a bonding material to an axially facing surface of each magnet of the plurality of magnets that faces an adjacent magnet of the plurality of magnets such that a final assembled rotor assembly does not include material between axially facing surfaces of adjacent magnets of the plurality of magnets.

In at least some embodiments, the method further includes arranging the plurality of magnets on the radially outer wall in axial alignment with each other so as to form an axial row of magnets, the bonding material securing the plurality of magnets to the radially outer wall, and arranging an annular retaining sleeve around the plurality of magnets such that the annular retaining sleeve radially surrounds the plurality of magnets so as to structurally support and secure the plurality of magnets to the rotor, the annular retaining sleeve being elastically deformable in the radial direction.

In at least some embodiments, the method further includes rotating the hollow rotor about the axis such that the radially outer wall of the hollow rotor elastically deform radially outwardly, sliding the plurality of magnets radially relative to each other in response to the elastic deformation in the radial direction of the radially outer wall, the plurality of magnets remaining in contact with the radially outer wall in response to the elastic deformation, and elastically deforming the annular retaining sleeve in the radial direction in response to the radial movement of the plurality of magnets.

These and other features of the present disclosure will become more apparent from the following description of the illustrative embodiments.

### BRIEF DESCRIPTION OF THE DRAWINGS

FIG. 1 is a perspective view of an illustrative embodiment of a gas turbine engine including an inlet, a fan, a compressor section, a combustor, a turbine section, and a rotor assembly in accordance with the present disclosure, the rotor assembly being part of an electric device (which may be a motor, generator, or motor-generator) located near the fan and compressor section and including a rotor coupled with a shaft, a plurality of magnets arranged radially outward of the rotor, the rotor and the plurality of magnets configured for rotation relative to a stator of the electric device;

FIG. 2 is a cross-sectional view of the rotor assembly included in the electric device of FIG. 1 at a low or zero RPM speed and showing that the rotor assembly includes the rotor, the plurality of magnets arranged radially outside of the rotor, and an annular retaining sleeve arranged radially outside of the plurality of magnets;

FIG. 3 is a cross-sectional view of the electric device of FIGS. 1 and 2 showing, in exaggerated form, the rotor elastically deformed in the radial direction in response to rotating at relatively higher RPM speeds and the plurality of magnets radially sliding relative to each other along each of their axial faces while remaining in contact with the outer surface of the rotor in response to the rotor ballooning, and showing that the annular retaining sleeve elastically deforms in response to the radially sliding of the plurality of magnets; and

FIG. 4 is an axially facing cross-sectional view of the rotor assembly of FIG. 2, showing that the rotor assembly may include a plurality of axial rows of magnets arranged circumferentially around the rotor, and showing that the rotor and annular retaining sleeve extend circumferentially around the central axis of the rotor assembly.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

Gas turbine engines may be adapted for various uses, such as to propel aircraft, watercraft, and/or for power generation. In such adapted vehicle use, electric motor assist may be used to supplement rotational force from the engine to propel the engine and aircraft and/or to power engine accessories. Moreover, general electrical power demands on gas turbine engines adapted for such uses are rapidly increasing due to the growing number and power requirement of processors, actuators, and accessories.

The present disclosure includes descriptions of gas turbine engines that include electric devices (such as electric motors, generators, and/or motor-generators) configured to create and/or supply electric power. While electric motors and electric generators each perform respective function, motor-generators include electrical devices that can be selectively operated in a generation mode to generate electricity for use in other systems and in a drive mode to drive mechanical rotation by consumption of electrical power. Such arrangements can promote operational flexibility and power management optimization.

In the illustrative embodiment, a turbofan gas turbine engine 100 includes a fan 112, a compressor 114, a combustor 116, and a turbine 118, as shown in FIG. 1. As explained in additional detail herein, the turbine 118 illustratively includes a high pressure (HP) turbine section 120 and a low pressure (LP) turbine section 122. The LP turbine section 122 is connected with and drives rotation of the fan 112 to provide thrust and may draw air into the compressor 114 and power a low pressure section of the compressor 114. The HP turbine section 120 is connected with and drives rotation of the compressor 114 or high pressure section of the compressor that compresses and delivers the air to the combustor 116. The combustor 116 mixes fuel with the compressed air from the compressor 114 and combusts the mixture. The hot, high-pressure exhaust products of the combustion reaction in the combustor 116 are directed into the turbine 118 to cause rotation of the HP and LP turbine sections 120, 122 about an axis 111 to drive the compressor 114 and the fan 112, respectively.

In the illustrative embodiment, the engine 100 includes an electrical device 20, as shown in FIGS. 1-4. The electrical device 20 is illustratively embodied as a motor-generator adapted to either generate electrical power through conversion of rotational motion. In some embodiments, the electrical device 20 may be only an electrical motor adapted to provide assistive rotational force, only an electrical generator adapted to generate electrical power from rotational motion, or a motor-generator as in the illustrative embodiment configured to provide assistive rotational force and/or generate electrical power. In some embodiments, the electrical device 20 is arranged axially between the fan 112 and the compressor 114. In some embodiments, the electrical device 20 is coupled with a power gear box that is connected with the fan 112 and turbine section 118.

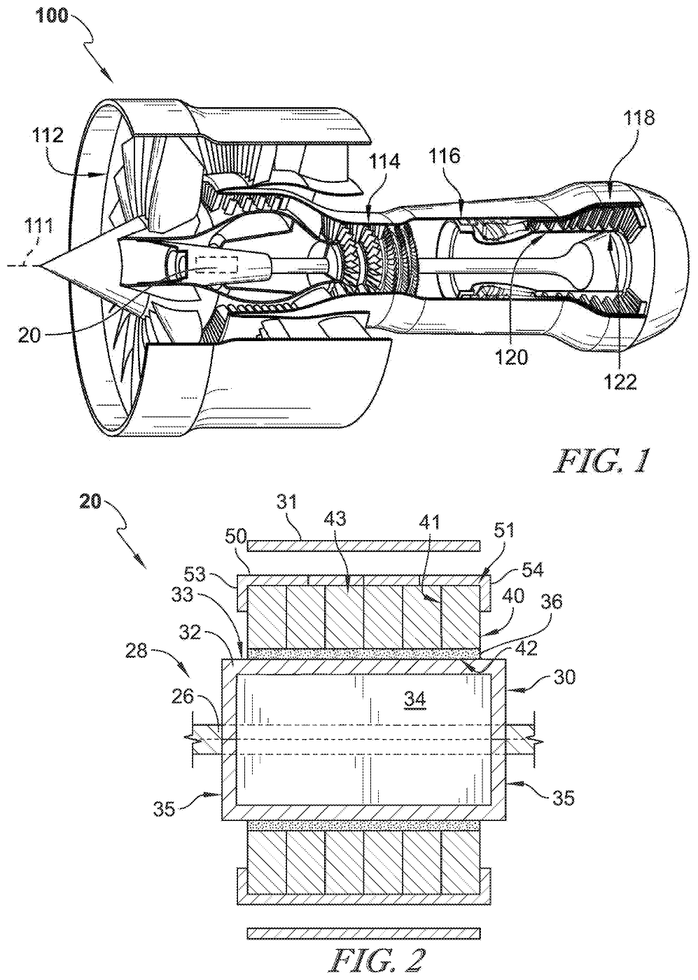

The electrical device 20 is secured with a drive shaft 26 of the engine 100 for rotation, as shown in FIGS. 2-4. In the illustrative embodiment, the driver shaft 26 extends along the axis 111 and that rotationally couples the fan 112 to receive driven rotation from an LP or HP turbine rotor of the HP turbine section 120 or the LP turbine section 122.

The electrical device 20 illustratively includes a rotor assembly 28 and a stator 31, as shown in FIGS. 2-4. The rotor assembly 28 includes a rotor 30 secured to rotate with the shaft 26, the rotor 30 having a radially outer wall 32. In some embodiments, the rotor 30 is integrally formed with the shaft 26. The electrical device 20 further includes a plurality of magnets 40 fixedly attached to an outer surface 33 of the radially outer wall 32 of the rotor 30. The electrical device 20 also includes an annular retaining sleeve 50 that radially surrounds the plurality of magnets 40 so as to structurally support and secure the magnets 40 to the rotor 30. Although not illustrated, the plurality of magnets 40 are positioned so as to electromagnetically interact with a stator provided in the electrical device 20. The stator 31 is arranged circumferentially around the rotor assembly 28.

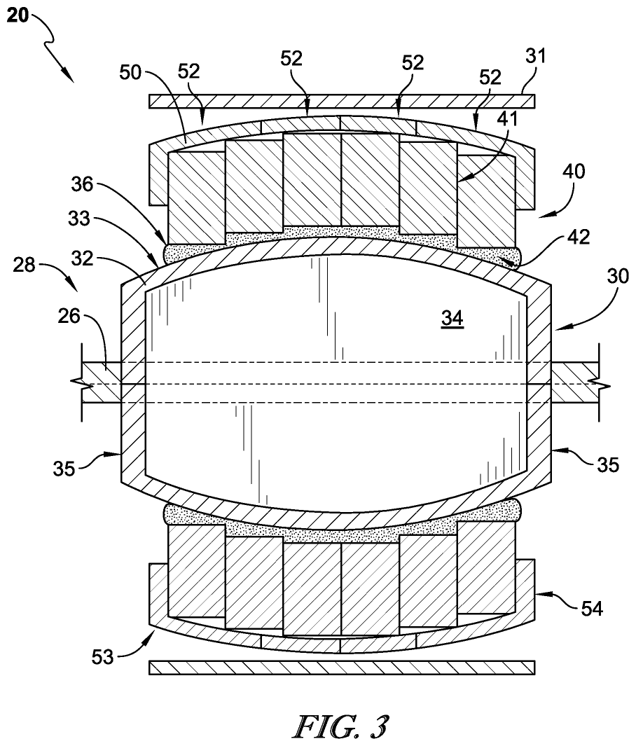

The rotor 30 is fixedly coupled to the drive shaft 26, as shown in FIGS. 2 and 3. The rotor 30 may include axially terminal end walls 35 through which the drive shaft 26 extends. In some embodiments, the drive shaft 26 is coupled to the axially terminal end walls 35 such that the rotor 30 rotates with the drive shaft 26. The rotor 30 may have a radius of 102 mm.

The rotor 30 of the rotor assembly 28 includes the radially outer wall 32, as shown by FIGS. 2-4. The radially outer wall 32 is annular and extends circumferentially around the entirety of the rotor 30 so as to enclose the radially inner area 34 of the rotor 30. The radially outer wall 32 may be formed as an annular wall having a radial thickness of 3 mm. The radially outer wall 32 is also elastically deformable, specifically in the radial direction. The elastic deformability of the radially outer wall 32 allows for deformation of the core wall 32 due to centrifugal forces acting on the rotor 30 during the high speed rotation of the rotor assembly 28 (the rotor assembly 28 is configured to rotate at speeds of 10,000 RPM up to 13,600 RPM). In order to provide for the appropriate deformability, the Young's modulus of the material that comprises the rotor 30 and the radially outer wall 32 is in the range of 160 GPa to 210 GPa in some embodiments.

As shown in FIGS. 2 and 3, the radially outer wall 32 may extend axially beyond the plurality of magnets 40 on both a forward and an aft end of the plurality of magnets 40 when the magnets 40 are axially aligned with each other. In other embodiments, the axial extent of the radially outer wall 32 may be equal to the axial extent of the plurality of magnets 40.

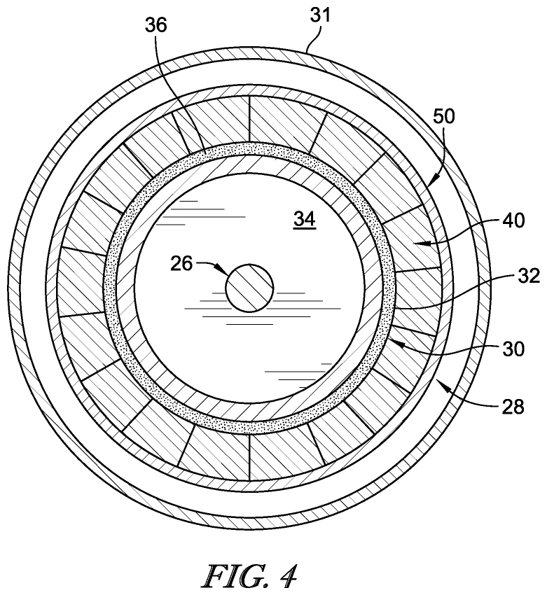

The rotor assembly 28 further includes the plurality of magnets 40 located radially outward of the rotor 30, as shown in FIGS. 2-4. The plurality of magnets 40 are arranged on the outer surface 33 of the radially outer wall 32 in axial alignment with each other. The magnets 40 may be embodied as a permanent magnet, but in some embodiments, the magnets 40 may include electromagnets. In the illustrative embodiment, the magnets 40 are comprised of samarium cobalt, although other high-energy materials may be utilized in other embodiments. The magnets 40 may be formed as rectangular prisms, as shown in FIGS. 2 and 3, each having a radial thickness of 8 mm and an axial thickness of 6 mm. In other words, the magnets 40 have a rectangular shape when viewed circumferentially as shown in FIG. 2 and a wedge shape when viewed axially as shown in FIG. 4. In some embodiments, the magnets 40 may be formed to have alternative shapes, so long as the magnets 40 are able to move radially relative to each other, as will be discussed in greater detail below. In at least some embodiments, the magnets 40 are sized such that a ratio of the radial thickness of the magnets 40 to the radial thickness of the radially outer wall 32 is 8 to 3.

Each magnet 40 of the plurality of magnets 40 includes an axially facing surface 41 facing an adjacent magnet 40 and a radially inward facing surface 42 facing the outer surface 33 of the radially outer wall 32, as shown in FIGS. 2 and 3. In the illustrative embodiment, a bonding material 36 is disposed between the radially inward facing surface 42 of each magnet 40 and the outer surface 33 of the radially outer wall 32 for securing the magnet to the radially outer wall 32. In other embodiments, the magnets 40 may be secured in place against the radially outer wall 32 via the annular retaining sleeve 50, which will be described in detail below. In such an embodiment, no bonding material is required to be disposed between the radially inward facing surface 42 of each magnet 40 and the outer surface 33 of the radially outer wall 32 because the radially inward force created by the annular retaining sleeve secures the magnets 40 to the radially outer wall 32.

The bonding material 36 may include any material capable of securing the plurality of magnets 40 to the radially outer wall 32. The bonding material 36 may also be selected in order to electrically insulate the plurality of magnets 40 from the rotor 30. For example, the bonding material 36 may include an adhesive, electrical tape with insulating properties, or other similar materials. In the illustrative embodiment, the bonding material 36 remains in contact with both the radially inward facing surfaces 42 of the magnets 40 and the outer surface 33 of the radially outer wall 32 throughout an entirety of the radial movement of the magnets 40. FIG. 3 shows the bonding material 36 applied between the radially inward facing surfaces 42 and the outer surface 33 of the radially outer wall 32 in greatly exaggerated fashion. As can be seen in FIG. 3, the bonding material is capable of expanding due to the radially movement of the magnets 40 while maintaining a bond between the radially inward facing surfaces 42 and the outer surface 33 of the radially outer wall 32.

In the illustrative embodiment, each axially facing surface 41 of each magnet 40 contacts an axially facing surface 41 of an adjacent magnet 40, as shown in FIGS. 2 and 3. Only the axially forward facing surface of the forwardmost magnet 40 and the axially aft facing surface of the aftmost magnet 40 do not contact an axially facing surface of two adjacent magnets. The axially facing surface 41 of each magnet 40 of the plurality of magnets 40 does not have a bonding material disposed thereon so as to allow for movement of the plurality of magnets 40 relative to each other, in particular in the radial direction due to elastic deformation of the radially outer wall 32, as will be described in greater detail below. Specifically, the axially facing surfaces 41 of the magnets 40 are not coupled to each other, or in other words, material-free, or in other words, configured to slide along an adjacent axially facing surface 41, or in other words, configured to move radially relative to each other. In some embodiments, KAPTOM™ tape may be applied between the magnets 40, although this tape still allows for radial movement between axially contacting magnets 40. The coefficient of friction between the axially facing surfaces 41 of the magnets 40 may be in the range of 0 to 0.3.

In the illustrative embodiment, the plurality of magnets 40 formed to be identical so as to form an axial row of magnets having an even radial extent along the entire axial row. In other embodiments, the magnets 40 may have staggered radial extents, so long as the annular retainer sleeve 50 and/or the bonding material 36 between the radially inward facing surface 42 of the magnets 40 keep the magnets 40 secured to the rotor 30. In the illustrative embodiment, the rotor assembly 28 includes a plurality of axial rows of magnets 40 arranged circumferentially around the radially outer wall 32 of the rotor 30, as shown in FIG. 4.

The rotor assembly 28 further includes the annular retaining sleeve 50, as shown in FIGS. 2-4. The annular retaining sleeve 50 radially surrounds the plurality of magnets 40 so as to structurally support and secure the plurality of magnets 40 to the radially outer wall 32 of the rotor 30. The annular retaining sleeve 50 may be formed as an annular wall having a radial thickness of 2.5 mm. The annular retaining sleeve 50 may be formed such that an inner surface 51 of the sleeve 50 matches the radially outer surfaces 43 of the magnets 40. For example, in embodiments in which the radial extent of the magnets 40 are staggered, the inner surface 51 of the sleeve 50 may be shaped to match the staggered radial extents of the magnets 40. In at least some embodiments, the annular retaining sleeve 50 is sized such that a ratio of the radial thickness of the radially outer wall 32 to radial thickness of the annular retaining sleeve 50 is 6 to 5. Moreover, in some embodiments, the annular retaining sleeve 50 includes a plurality of annular ring segments 52 arranged axially adjacent to each other so as to form the annular retaining sleeve 50. The axial extent of each ring segment 52 is 2 mm.

In the illustrative embodiment, the annular retaining sleeve 50 is elastically deformable, in particular in the radial direction. Due to the deformation of the core wall 32 caused by centrifugal forces acting on the rotor 30 during the high speed rotation of the rotor assembly 28, the magnets 40 may move radially relative to each other, as will be discussed in greater detail below. In order to provide for the appropriate deformability of the annular retaining sleeve 50 to accommodate the radial movement of the magnets 40, the Young's modulus of the material that comprises the annular retaining sleeve 50 is in the range of 180 GPa to 210 GPa.

In the illustrative embodiment, the plurality of magnets 40 are secured against the outer surface 33 of the radially outer wall 32 via both the bonding material 36 applied between the radially inward facing surfaces 42 of the magnets 40 and the radially inward force applied to the magnets 40 via the annular retaining sleeve 50. In other embodiments, the annular retaining sleeve 50 is configured to retain the plurality of magnets 40 in engagement against the radially outer wall 32 of the rotor 30 without bonding material applied between the magnets 40 and the outer surface 33.

In the illustrative embodiment, the annular retaining sleeve 50 includes a forward radially extending end wall 53 extending away from a forward end of the annular retaining sleeve 50 and an aft radially extending end wall 54 extending away from an aft end of the annular retaining sleeve 50, as shown in FIGS. 2 and 3. The forward radially extending end wall 53 and the aft radially extending end wall 54 enclose at least a portion of an axially forwardmost magnet of the plurality of magnets 40 and at least a portion of an axially aftmost magnet of the plurality of magnets 40 so as to retain the plurality of magnets 40 in the axial direction. This prevents sliding of the magnets 40 in the axial direction, as well as maintaining the position of the magnets 40 relative to the radially outer wall 32.

In operation, at least the radially outer core wall 32 of the rotor 30 may elastically deform, in particular in the radial direction, due to centrifugal forces acting on the rotor assembly 28 as it rotates at high speeds. When the radially outer core wall 32 deforms, it may deform such that portions of the rotor along the axial direction have a greater radial height when compared to other portions, as can be seen in FIGS. 2 and 3 (the deformation is shown extremely exaggerated in these figures). For example, the forces acting on the rotor 30 due to the high speed rotation may cause the central portion of the radially outer wall 32 to deform to a greater extent than the axial ends of the core wall 32 creating a curved wall. The deformation may take the form of 1^{st}, 2^{nd}, 3^{rd} etc. order responses.

As a result of this deformation, the magnets 40 arranged on the central portion of the radially outer wall 32 will be forced to move radially outwardly more than the magnets 40 arranged toward the axial ends of the core wall 32 in the present example, as shown in FIGS. 2 and 3. Thus, in order to accommodate for this movement of the magnets 40, the magnets 40 are configured to move radially relative to each other in response to the deformation in the radial direction of the radially outer wall 32. As discussed above, this movement is enabled by the lack of bonding material or any other material applied between axially facing surfaces of adjacent magnets 40. However, the radially inward facing surfaces 42 of the magnets 40 may include bonding material to keep the magnets in secured engagement with the radially outer wall 32.

The annular retaining sleeve 50 is also configured to elastically deform in the radial direction in response to the radial movement of the plurality of magnets 40, as shown in FIGS. 2 and 3. In some embodiments, the inner surface 51 of the annular retaining sleeve 50 contacts at least a portion of the radially outer surface 43 of each magnet 40 in response to the radial movement of the plurality of magnets 40 relative to each other. In other embodiments, the annular retaining sleeve 50 need not contact the radially outer surface 43 of every magnet 40.

The plurality of magnets 40 being held against or fixed to the rotor 30 only on the radially inward facing surfaces 42 and being permitted to slide along their axially facing surfaces 41 allows for the radially outer wall 32, and thus the rotor 30, to be relatively thin such that elastic deflection of the rotor 30 may occur during operation. As a result, the magnets 40 do not add stiffness to the assembly, but instead permit flexibility of the rotor assembly 28. This is advantageous because any magnet lift-off from the rotor 30 may cause imbalance in the assembly. By avoiding adhesive, glue, bonding material, or any other material between magnet 40 segments, the pretension of annular retaining sleeve 50 is reduced, and the rotor assembly 28 may be slimmer and lightweight.

A method 200 of assembling a rotor of an electrical device for use in a gas turbine engine is shown in FIG. 5. The method 200 includes a first method operation 202 of providing a hollow rotor arranged to circumferentially surround a central axis of the engine, the hollow rotor having a radially outer wall that is elastically deformable in a radial direction.

The method 200 further includes a second method operation 204 of applying a bonding material to at least one of a radially inward facing surface of each magnet of a plurality of magnets and an outer surface of the radially outer wall without applying a bonding material to an axially facing surface of each magnet of the plurality of magnets that faces an adjacent magnet of the plurality of magnets such that a final assembled rotor assembly does not include material between axially facing surfaces of adjacent magnets of the plurality of magnets. The method 200 further includes a third method operation 206 of arranging the plurality of magnets on the radially outer wall in axial alignment with each other so as to form an axial row of magnets, the bonding material securing the plurality of magnets to the radially outer wall.

The method 200 further includes a fourth method operation 208 of arranging an annular retaining sleeve around the plurality of magnets such that the annular retaining sleeve radially surrounds the plurality of magnets so as to structurally support and secure the plurality of magnets to the hollow rotor, the annular retaining sleeve being elastically deformable in the radial direction. The method 200 may include additional operations of rotating the hollow rotor about the axis such that the radially outer wall of the hollow rotor elastically deform radially outwardly, sliding the plurality of magnets radially relative to each other in response to the elastic deformation in the radial direction of the radially outer wall, the plurality of magnets remaining in contact with the radially outer wall in response to the elastic deformation, and elastically deforming the annular retaining sleeve in the radial direction in response to the radial movement of the plurality of magnets.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A gas turbine engine comprising
a fan arranged around an axis and configured to generate thrust, a turbine configured to generate rotational energy, and a drive shaft that extends along the axis and transfers the rotational energy from the turbine to the fan, and
a rotor assembly for a motor-generator, the rotor assembly including
(i) a rotor arranged to circumferentially surround the axis and rotationally coupled to the drive shaft, the rotor including a radially outer wall that is elastically deformable in a radial direction and having an axially forward end and an axially aft end, an axially forward annular end wall arranged on the axially forward end of the radially outer wall, and an axially aft annular end wall arranged on the axially aft end of the radially outer wall, the radially outer wall being spaced apart from the axis by the axially forward and the axially aft annular end walls, wherein the radially outer wall is configured to elastically deform in the radial direction in response to centrifugal forces acting on the rotor during high-speed rotation of the rotor such that a first portion of the radially outer wall located at a first axial position of the radially outer wall deforms a first radial distance and a second portion of the radially outer wall located at a second axial position of the radially outer wall spaced apart from the first axial position deforms a second radial distance different than the first radial distance,
(ii) a plurality of magnets located radially outward of the rotor and arranged on the radially outer wall in axial alignment with each other so as to form an axial row of magnets, the plurality of magnets being configured to move radially relative to each other and remain in contact with the radially outer wall in response to elastic deformation in the radial direction of the radially outer wall, and
(iii) an annular retaining sleeve radially surrounding the plurality of magnets so as to structurally support and secure the plurality of magnets to the rotor, the annular retaining sleeve being elastically deformable in the radial direction and configured to elastically deform in the radial direction based on the radial movement of the plurality of magnets, wherein a first portion of the annular retaining sleeve located at a first axial position of the annular retaining sleeve deforms a first radial distance and a second portion of the annular retaining sleeve located at a second axial position of the annular retaining sleeve spaced apart from the first axial position deforms a second radial distance different than the first radial distance,
wherein each magnet of the plurality of magnets includes an axially facing surface facing an adjacent magnet, and wherein each magnet of the plurality of magnets is in contact with each other on the axially facing surface of each magnet.

2. The gas turbine engine of claim 1, wherein the radially outer wall includes a radially outer surface, wherein each magnet of the plurality of magnets further includes a radially inward facing surface facing the radially outer wall, and wherein a bonding material is disposed between the radially inward facing surface of each magnet of the plurality of magnets and the radially outer surface of the radially outer wall for securing the magnet to the radially outer wall.

3. The gas turbine engine of claim 2, wherein the axially facing surface of each magnet of the plurality of magnets is material-free so as to allow for the radial movement of the plurality of magnets relative to each other.

4. The gas turbine engine of claim 3, wherein each magnet of the plurality of magnets includes a radially outer surface, and wherein the annular retaining sleeve contacts at least a portion of the radially outer surface of each magnet of the plurality of magnets in response to the radial movement of the plurality of magnets relative to each other.

5. (canceled)

6. The gas turbine engine of claim 4, wherein the annular retaining sleeve has an axially forward end and an axially aft end, wherein the annular retaining sleeve includes a forward radially extending end wall extending away from the axially forward end of the annular retaining sleeve and an aft radially extending end wall extending away from the axially aft end of the annular retaining sleeve, and wherein the forward radially extending end wall and the aft radially extending end wall enclose at least a portion of an axially forwardmost magnet of the plurality of magnets and at least a portion of an axially aftmost magnet of the plurality of magnets so as to retain the plurality of magnets in an axial direction.

7. The gas turbine engine of claim 1, wherein the radially outer wall defines a rotor wall radial thickness, the annular retaining sleeve defines a sleeve radial thickness, and a ratio of the rotor wall radial thickness to the sleeve radial thickness is 6 to 5.

8. The gas turbine engine of claim 1, wherein the radially outer wall defines a rotor wall radial thickness, each magnet of the plurality of magnets defines a magnet radial thickness, and a ratio of the magnet radial thickness to the rotor wall radial thickness is 8 to 3.

9. The gas turbine engine of claim 1, wherein the radially outer wall defines a rotor wall radial thickness of 3 mm, each magnet of the plurality of magnets defines a magnet radial thickness of 8 mm, and the annular retaining sleeve defines a sleeve radial thickness of 2.5 mm.

10. The gas turbine engine of claim 1, wherein the Young's modulus of the radially outer wall is in a range of 160 GPa to 210 GPa, and the Young's modulus of the annular retaining sleeve is in a range of 180 GPa to 210 GPa.

11. The gas turbine engine of claim 1, wherein the plurality of magnets are made of samarium cobalt.

12. The gas turbine engine of claim 1, wherein the rotor assembly includes a plurality of axial rows of magnets arranged circumferentially around the radially outer wall of the rotor.

13. The gas turbine engine of claim 1, wherein the annular retaining sleeve includes a plurality of annular ring segments arranged axially adjacent to each other so as to form the annular retaining sleeve.

14. A rotor assembly of an electrical device for use in a gas turbine engine, the rotor assembly comprising
a hollow rotor configured to rotate about an axis and deform elastically radially in response to rotation about the axis, the hollow rotor including a radially outer wall that is annular and is configured to rotate about the axis, wherein the radially outer wall is configured to elastically deform in the radial direction in response to centrifugal forces acting on the hollow rotor during high-speed rotation of the hollow rotor such that a first portion of the radially outer wall located at a first axial position of the radially outer wall deforms a first radial distance and a second portion of the radially outer wall located at a second axial position of the radially outer wall spaced apart from the first axial position deforms a second radial distance different than the first radial distance,
a plurality of magnets arranged radially outward of the hollow rotor so as to form an axial row whereby the plurality of magnets are aligned circumferentially, and
an annular retaining sleeve radially surrounding the plurality of magnets so as to structurally support and secure the plurality of magnets with the hollow rotor, the annular retaining sleeve being elastically deformable,
wherein a first portion of the annular retaining sleeve located at a first axial position of the annular retaining sleeve deforms a first radial distance and a second portion of the annular retaining sleeve located at a second axial position of the annular retaining sleeve spaced apart from the first axial position deforms a second radial distance different than the first radial distance, and
wherein the plurality of magnets are not coupled with one another to allow the plurality of magnets to move relative to each other in response to elastic deformation of the hollow rotor, and the annular retaining sleeve is configured to elastically deform with the radial movement of the plurality of magnets while retaining the plurality of magnets in contact with the hollow rotor,
wherein each magnet of the plurality of magnets includes an axially facing surface facing an adjacent magnet, and wherein each magnet of the plurality of magnets is in contact with each other on the axially facing surface of each magnet.

15. The gas turbine engine of claim 15, wherein each magnet of the plurality of magnets further includes a radially inward facing surface that faces the hollow rotor, wherein a bonding material is disposed between the radially inward facing surface of each magnet of the plurality of magnets and the hollow rotor to couple the plurality of magnets with the hollow rotor.

16. The gas turbine engine of claim 16, wherein the axially facing surface of each magnet of the plurality of magnets and any axial space between adjacent magnets is free of material so as to allow for the radial movement of the plurality of magnets relative to each other.

17. The gas turbine engine of claim 17, wherein each magnet of the plurality of magnets includes a radially outer surface, and wherein the annular retaining sleeve contacts at least a portion of the radially outer surface of each magnet of the plurality of magnets in response to the movement of the plurality of magnets relative to each other.

18. (canceled)

19. A method of assembling a rotor assembly of an electrical device for use in a gas turbine engine, the method comprising
providing a hollow rotor arranged to circumferentially surround a central axis of the engine, the hollow rotor having a radially outer wall that is elastically deformable in a radial direction, wherein the radially outer wall is configured to elastically deform in the radial direction in response to centrifugal forces acting on the rotor during high-speed rotation of the rotor such that a first portion of the radially outer wall located at a first axial position of the radially outer wall deforms a first radial distance and a second portion of the radially outer wall located at a second axial position of the radially outer wall spaced apart from the first axial position deforms a second radial distance different than the first radial distance,
applying a bonding material to at least one of a radially inward facing surface of each magnet of a plurality of magnets and an outer surface of the radially outer wall without applying a bonding material to an axially facing surface of each magnet of the plurality of magnets that faces an adjacent magnet of the plurality of magnets such that a final assembled rotor assembly does not include material between axially facing surfaces of adjacent magnets of the plurality of magnets,
arranging the plurality of magnets on the radially outer wall in axial alignment with each other so as to form an axial row of magnets, the bonding material securing the plurality of magnets to the radially outer wall, and
arranging an annular retaining sleeve around the plurality of magnets such that the annular retaining sleeve radially surrounds the plurality of magnets so as to structurally support and secure the plurality of magnets to the rotor, the annular retaining sleeve being elastically deformable in the radial direction, wherein a first portion of the annular retaining sleeve located at a first axial position of the annular retaining sleeve deforms a first radial distance and a second portion of the annular retaining sleeve located at a second axial position of the annular retaining sleeve spaced apart from the first axial position deforms a second radial distance different than the first radial distance,
wherein the annular retaining sleeve has an axially forward end and an axially aft end, wherein the annular retaining sleeve includes a forward radially extending end wall extending away from the axially forward end of the annular retaining sleeve and an aft radially extending end wall extending away from the axially aft end of the annular retaining sleeve, wherein the forward radially extending end wall and the aft radially extending end wall enclose at least a portion of an axially forwardmost magnet of the plurality of magnets and at least a portion of an axially aftmost magnet of the plurality of magnets so as to retain the plurality of magnets in an axial direction, and wherein an open space is formed between radially inner ends of the forward and aft radially extending end walls and the outer surface of the radially outer wall so as to allow for axial deformation of the radially outer wall.

20. The method of claim 19, further comprising
rotating the hollow rotor about the axis such that the radially outer wall of the hollow rotor elastically deform radially outwardly,
sliding the plurality of magnets radially relative to each other in response to the elastic deformation in the radial direction of the radially outer wall, the plurality of magnets remaining in contact with the radially outer wall in response to the elastic deformation, and
elastically deforming the annular retaining sleeve in the radial direction in response to the radial movement of the plurality of magnets.
